(19) United States
(12) Patent Application Publication
(10) Pub. No.: US 2026/0134804 A1
(43) Pub. Date: May 14, 2026

(54) Display Device

(71) Applicant: LG Display Co., Ltd., Seoul (KR)

(72) Inventors: Dongkyun Woo, Paju-si (KR); JaeKyeong Yun, Paju-si (KR)

(21) Appl. No.: 19/188,526

(22) Filed: Apr. 24, 2025

(30) Foreign Application Priority Data
Nov. 8, 2024 (KR) 10-2024-0157824

(51) Int. Cl. G09G 3/00

(52) U.S. Cl. CPC G09G 3/006; G09G 2330/12

(57) ABSTRACT

A display device is disclosed. More specifically, a display device is disclosed that is capable of easily identifying misalignment errors between a display panel and a film by using film pads with different widths.

### CROSS REFERENCE TO RELATED APPLICATION

This application claims priority from Republic of Korea Patent Application No. 10-2024-0157824, filed on Nov. 8, 2024, which is hereby incorporated by reference in its entirety.

### TECHNICAL FIELD

Embodiments of the present disclosure relate to a display device.

### BACKGROUND

With the advancement of the information society, there is an increasing demand for display devices that present images. Various types of display devices, such as liquid crystal displays (LCDs) and organic light-emitting displays (OLEDs), are being utilized.

Among these, organic light-emitting displays offer advantages such as fast response time, high contrast ratio, excellent luminous efficiency, brightness, and wide viewing angles by utilizing self-emissive organic light-emitting diodes (OLEDs).

An organic light-emitting display includes a plurality of sub-pixels arranged in a display panel, each of which contains an organic light-emitting diode (OLED). The OLEDs emit light by controlling the current flowing through them, thereby adjusting the brightness of each sub-pixel and displaying an image.

In some display devices, a chip-on-film (COF) structure is employed, where a driving circuit is mounted on a film and electrically connected to signal lines of the display panel.

To achieve this, the chip-on-film may include a plurality of pads that electrically contact the signal lines of the display panel.

In particular, the chip-on-film includes alignment test pads to optically determine alignment errors when bonding the display panel and the chip-on-film.

However, the alignment error detection method using these alignment test pads has limitations. Specifically, in environments where optical measurements using a microscope or similar tools are difficult, it becomes challenging to accurately determine whether an alignment error has occurred. Accordingly, there is a growing demand for technology that can accurately detect alignment errors even in environments where optical measurement is difficult.

### SUMMARY

Embodiments of the present disclosure may provide a display device that enables easy identification of alignment errors between a display panel and a film, even in environments where optical measurement is not feasible, by utilizing an electrical measurement method.

Embodiments of the present disclosure may provide a display device capable of identifying alignment errors between the display panel and the film based on bonding resistance measurements obtained through a plurality of pads having different widths.

Embodiments of the present disclosure may provide a display device in which a plurality of pads having different widths are designed asymmetrically thereby allowing the detection of the misalignment direction when an alignment error occurs.

Embodiments of the present disclosure may provide a display device capable of more accurately determining the occurrence of an alignment error using a plurality of pads having different widths and optimizing the manufacturing process based on the measurement results.

Embodiments of the present disclosure may provide a display device comprising: a first pad portion, in which a plurality of first film pads are arranged; a second pad portion, including a plurality of second film pads arranged on at least one of a first side and a second side of the first pad portion, and a plurality of test terminals electrically connected to each of the plurality of second film pads through test line; and at least one driving circuit electrically connected to the plurality of first film pads, wherein at least two of the plurality of film test pads have different widths.

Embodiments of the present disclosure may provide a display device comprising: a display panel, including a display area where a plurality of sub-pixels are arranged and a non-display area where a first driving circuit and a plurality of panel test pads are arranged; at least one source film, where a plurality of film test pads corresponding to each of the plurality of panel test pads and connected to each of a plurality of test terminals through test line, and a second driving circuit are arranged; and a control board, where a controller is disposed to control both the first and second driving integrated circuits, wherein at least two of the plurality of film test pads have different widths.

According to embodiments of the present disclosure, a display device capable of easily identifying alignment errors between a display panel and a film, even in environments where optical measurement is not feasible, may be provided by using an electrical measurement method.

According to embodiments of the present disclosure, a display device capable of identifying alignment errors between a display panel and a film based on bonding resistance measurements obtained through a plurality of pads having different widths may be provided.

According to embodiments of the present disclosure, a display device in which a plurality of pads having different widths are designed asymmetrically may be provided, enabling the detection of the misalignment direction when an alignment error occurs.

According to embodiments of the present disclosure, a display device capable of more accurately determining the occurrence of an alignment error using a plurality of pads having different widths and optimizing the manufacturing process based on the measurement results may be provided.

### BRIEF DESCRIPTION OF THE DRAWINGS

FIG. 1 is a diagram illustrating a display device according to embodiments of the present disclosure.

FIG. 2 is a diagram illustrating an implementation example of a display device according to embodiments of the present disclosure.

FIG. 3 is a diagram illustrating an example of a sub-pixel included in a display device according to embodiments of the present disclosure.

FIG. 4 and FIG. 5 are diagrams illustrating film pads included in a display device according to embodiments of the present disclosure.

FIG. 6 and FIG. 7 are diagrams illustrating an example of determining an alignment error in a display device according to embodiments of the present disclosure.

FIG. 8 to FIG. 10 are diagrams illustrating an example of deriving a misalignment direction in a display device according to embodiments of the present disclosure.

### DETAILED DESCRIPTION

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description may make the subject matter in some embodiments of the present invention rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Various embodiments of the present specification will be described in detail with reference to the accompanying drawings.

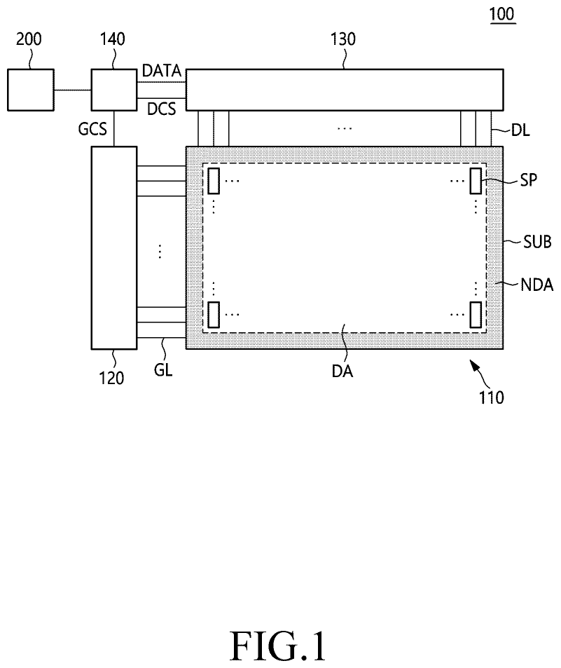

FIG. 1 is a diagram for explaining a display device 100 according to embodiments of the present disclosure.

Referring to FIG. 1, the display device 100 according to embodiments of the present disclosure may include a display panel 110 and a driving circuit for driving the display panel 110.

The display panel 110 may include a display area DA where an image is displayed and a non-display area NDA where an image is not displayed. The non-display area NDA may also be referred to as a bezel area.

The display panel 110 may include a plurality of sub-pixels SP for image display. For example, the plurality of sub-pixels SP may be arranged in the display area DA. In some cases, at least one sub-pixel SP may be disposed in the non-display area NDA. The at least one sub-pixel SP arranged in the non-display area NDA may also be referred to as a dummy sub-pixel.

The display panel 110 may include a plurality of signal lines for driving the plurality of sub-pixels SP. For example, the plurality of signal lines may include a plurality of data lines DL and a plurality of gate lines GL. Depending on the structure of the sub-pixels SP, the signal lines may further include signal lines other than the plurality of data lines DL and the plurality of gate lines GL. For example, the other signal lines may include a driving voltage line and a reference voltage line.

The plurality of data lines DL and the plurality of gate lines GL may intersect each other. Each of the plurality of data lines DL may be arranged to extend in a first direction, and each of the plurality of gate lines GL may be arranged to extend in a second direction. Here, the first direction may correspond to a column direction, and the second direction may correspond to a row direction. In this disclosure, the column direction and the row direction are relative concepts. For example, the column direction may be a vertical direction, and the row direction may be a horizontal direction. In another example, the column direction may be a horizontal direction, and the row direction may be a vertical direction.

The driving circuit may include a data driving circuit 130 for driving the plurality of data lines DL and a gate driving circuit 120 for driving the plurality of gate lines GL. The driving circuit may further include a timing controller 140 for controlling the data driving circuit 130 and the gate driving circuit 120.

Hereinafter, one of the data driving circuit 130 and the gate driving circuit 120 may be referred to as a first driving circuit, and the other may be referred to as a second driving circuit.

The data driving circuit 130 is a circuit for driving the plurality of data lines DL and may output a data signal (also referred to as a data voltage) corresponding to an image signal through the plurality of data lines DL. The gate driving circuit 120 is a circuit for driving the plurality of gate lines GL and may generate and output gate signals to the plurality of gate lines GL. The gate signals may include one or more scan signals and light-emission signals.

The timing controller 140 may initiate scanning according to the timing of each frame and control data driving at an appropriate time in synchronization with the scanning. The timing controller 140 may convert input image data received from an external source into a data signal format used by the data driving circuit 130 and supply the converted image data DATA to the data driving circuit 130.

The timing controller 140 may receive display driving control signals from an external host system 200 along with the input image data. For example, the display driving control signals may include a vertical synchronization signal VSYNC, a horizontal synchronization signal HSYNC, an input data enable signal DE, and a clock signal CLK.

Based on the display driving control signals received from the host system 200, the timing controller 140 may generate a data driving control signal DCS and a gate driving control signal GCS. By supplying the data driving control signal DCS to the data driving circuit 130, the timing controller 140 may control the driving operation and timing of the data driving circuit 130. By supplying the gate driving control signal GCS to the gate driving circuit 120, the timing controller 140 may control the driving operation and timing of the gate driving circuit 120.

The timing controller 140 may be implemented as a separate component from the data driving circuit 130 or may be integrated with the data driving circuit 130 into an integrated circuit.

The data driving circuit 130 may include at least one source driving integrated circuit (SDIC). Each source driving integrated circuit may include a shift register, a latch circuit, a digital-to-analog converter (DAC), and an output buffer. Depending on embodiments, each source driving integrated circuit may further include an analog-to-digital converter (ADC).

For example, each source driving integrated circuit may be connected to the display panel 110 using a tape-automated bonding (TAB) method, may be bonded to bonding pads of the display panel 110 using a chip-on-glass (COG) or chip-on-panel (COP) method, or may be implemented as a chip-on-film (COF) and connected to the display panel 110.

According to an embodiment, when a source driving integrated circuit is implemented in a chip-on-film (COF) method and mounted on a source film, at least two second film pads having different widths may be arranged on the source film. Here, the second film pads may be used for measuring bonding resistance resulting from the bonding between the display panel 110 and the source film.

The gate driving circuit 120 may output a gate signal at a turn-on level voltage or a gate signal at a turn-off level voltage under the control of the timing controller 140. The gate driving circuit 120 may sequentially supply gate signals at the turn-on level voltage through the plurality of gate lines GL, thereby sequentially driving the plurality of gate lines GL.

The gate driving circuit 120 may include at least one gate driving integrated circuit (GDIC).

The gate driving circuit 120 may be connected to the display panel 110 using a tape-automated bonding (TAB) method, may be bonded to the bonding pads of the display panel 110 using a chip-on-glass (COG) or chip-on-panel (COP) method, or may be connected to the display panel 110 using a chip-on-film (COF) method. Alternatively, the gate driving circuit 120 may be formed in the non-display area NDA of the display panel 110 as a gate-in-panel (GIP) type. The gate driving circuit 120 may be disposed on a substrate or connected to a substrate. Specifically, when the gate driving circuit 120 is of the GIP type, it may be arranged in the non-display area NDA of the substrate. When the gate driving circuit 120 is of the COG type or COF type, it may be connected to the substrate.

According to an embodiment, when a gate driving integrated circuit is implemented in a chip-on-film (COF) method and mounted on a gate film, at least two second film pads having different widths may be arranged on the gate film. Here, the second film pads may be used for measuring bonding resistance resulting from the bonding between the display panel 110 and the gate film.

Meanwhile, at least one of the data driving circuit 130 and the gate driving circuit 120 may be arranged in the display area DA. For example, at least one of the data driving circuit 130 and the gate driving circuit 120 may be arranged not to overlap (non-overlapping) with the sub-pixels SP, or it may be arranged to partially or entirely overlap with the sub-pixels SP.

The data driving circuit 130 may be connected to one side (e.g., upper or lower side) of the display panel 110. Depending on the driving method and panel design method, the data driving circuit 130 may be connected to both sides (e.g., upper and lower sides) of the display panel 110, or it may be connected to at least two of the four sides of the display panel 110.

The gate driving circuit 120 may be connected to one side (e.g., left or right side) of the display panel 110. Depending on the driving method and panel design method, the gate driving circuit 120 may be connected to both sides (e.g., left and right sides) of the display panel 110, or it may be connected to at least two of the four sides of the display panel 110.

The timing controller 140 may be implemented as a separate component from the data driving circuit 130 or may be integrated into an integrated circuit along with the data driving circuit 130. The timing controller 140 may be a controller used in conventional display technologies or may be a control device that performs additional control functions, including timing control. It may also be a circuit within a control device. The timing controller 140 may be implemented using various circuits or electronic components, such as an integrated circuit (IC), a field-programmable gate array (FPGA), an application-specific integrated circuit (ASIC), or a processor.

The timing controller 140 may be mounted on a printed circuit board or a flexible printed circuit and electrically connected to the data driving circuit 130 and the gate driving circuit 120 through the printed circuit board or the flexible printed circuit. The timing controller 140 may transmit and receive signals with the data driving circuit 130 according to at least one predetermined interface. For example, the interface may include a low voltage differential signaling (LVDS) interface, an EPI interface, or serial peripheral interface (SPI).

The display device 100 according to embodiments of the present disclosure may be a self-emitting display device in which the display panel 110 emits light by itself. When the display device 100 according to embodiments of the present disclosure is a self-emitting display device, each of the plurality of sub-pixels SP may include a light-emitting device. For example, the display device 100 according to embodiments of the present disclosure may be an organic light-emitting display device in which the light-emitting device is implemented as an organic light-emitting diode (OLED). In another example, the display device 100 according to embodiments of the present disclosure may be an inorganic light-emitting display device in which the light-emitting device is implemented as an inorganic-based light-emitting diode. In yet another example, the display device 100 according to embodiments of the present disclosure may be a quantum dot display device in which the light-emitting device is implemented as a quantum dot, which is a semiconductor crystal that emits light by itself.

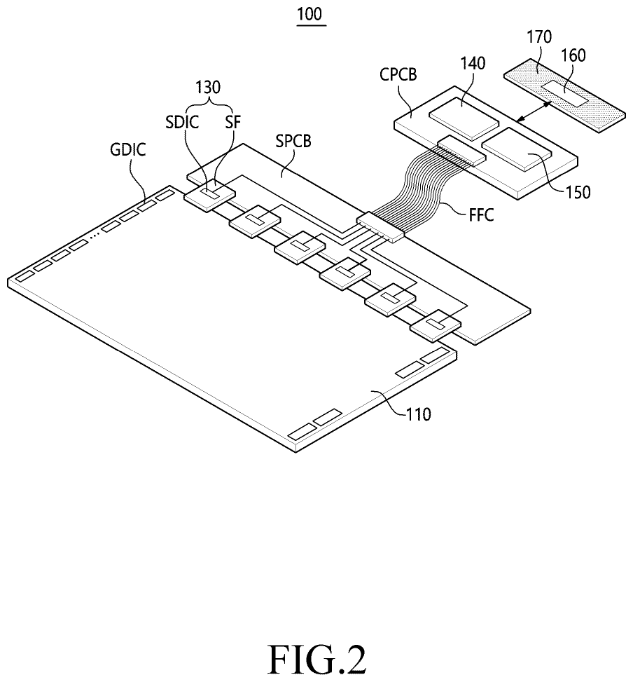

FIG. 2 is a diagram for explaining an implementation example of the display device 100 according to embodiments of the present disclosure.

Referring to FIG. 2, the display device 100 according to embodiments of the present disclosure may be implemented such that the data driving circuit 130 is implemented using a chip on film (COF) method among various methods (e.g., TAB, COG, COF, etc.), and the gate driving circuit 120 is implemented using a gate in panel (GIP) type among various methods (e.g., TAB, COG, COF, GIP, etc.). However, embodiments of the present disclosure are not limited thereto.

When the gate driving circuit 120 is implemented as a GIP type, the plurality of gate driving integrated circuits (GDICs) included in the gate driving circuit 120 may be directly formed in the non-display area of the display panel 110. In this case, the gate driving integrated circuits (GDICs) may receive various signals (e.g., clock signals, gate high signals, gate low signals, etc.) necessary for generating scan signals through gate-driving-related signal lines arranged in the non-display area.

Similarly, at least one source driving integrated circuit (SDIC) included in the data driving circuit 130 may be mounted on at least one source film SF, and one side of the source film SF may be electrically connected to the display panel 110. In addition, lines for electrically connecting the source driving integrated circuit (SDIC) and the display panel 110 may be arranged on the upper portion of the source film SF.

In the example of FIG. 2, the display device 100 is illustrated as including a plurality of source films SF and a plurality of source driving integrated circuits (SDICs) arranged on each of the plurality of source films SF. However, embodiments of the present disclosure are not limited thereto, and the display device 100 may include a single source film SF and a single source driving integrated circuit (SDIC) arranged on the single source film SF.

The display device 100 may include at least one source printed circuit board (SPCB) for circuit connections between at least one source driving integrated circuit (SDIC) and other devices and a control printed circuit board (CPCB) for mounting control components and various electrical devices. Hereinafter, the control printed circuit board may be referred to as a control board.

The other side of the source film SF on which the source driving integrated circuit (SDIC) is mounted may be connected to at least one source printed circuit board (SPCB). That is, the source film SF on which the source driving integrated circuit (SDIC) is mounted may have one side electrically connected to the display panel 110 and the other side electrically connected to the source printed circuit board (SPCB).

The control printed circuit board (CPCB) may have the timing controller 140 and the power management circuit 150 mounted thereon. The timing controller 140 may control the operation of the data driving circuit 130 and the gate driving circuit 120. The power management circuit 150 may supply a driving voltage or current to the display panel 110, the data driving circuit 130, and the gate driving circuit 120, and may control the supplied voltage or current.

At least one source printed circuit board (SPCB) and the control printed circuit board (CPCB) may be circuit-connected through at least one connection member, which may be, for example, a flexible printed circuit (FPC) or a flexible flat cable (FFC). Additionally, at least one source printed circuit board (SPCB) and the control printed circuit board (CPCB) may be integrated into a single printed circuit board.

The display device 100 may further include a set board 170 electrically connected to the control printed circuit board (CPCB). Here, the set board 170 may also be referred to as a power board. The set board 170 may include a main power management circuit 160 that manages the overall power of the display device 100. The main power management circuit 160 may be linked with the power management circuit 150.

In the case of the display device 100 configured as described above, the driving voltage is generated in the set board 170 and delivered to the power management circuit 150 within the control printed circuit board (CPCB). The power management circuit 150 may transmit the driving voltage required for display driving or characteristic sensing to the source printed circuit board (SPCB) through a flexible printed circuit (FPC) or a flexible flat cable (FFC). The driving voltage delivered to the source printed circuit board (SPCB) may be supplied through the source driving integrated circuit (SDIC) to emit or sense a specific sub-pixel SP within the display panel 110.

In this case, each sub-pixel SP arranged in the display panel 110 of the display device 100 may include a light-emitting device and circuit elements such as a driving transistor for driving the light-emitting device.

The types and numbers of circuit elements constituting each sub-pixel SP may be varied depending on the provided function and design method.

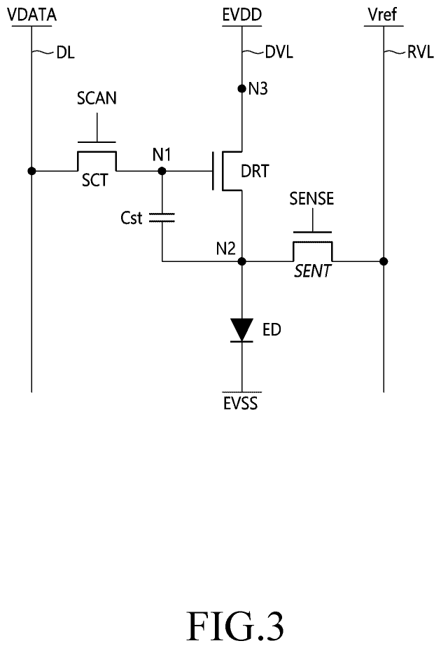

FIG. 3 is a diagram illustrating an example of a sub-pixel SP included in the display device 100 according to embodiments of the present disclosure.

Referring to FIG. 3, in the display device 100 according to embodiments of the present disclosure, the sub-pixel SP may include one or more transistors and capacitors.

For example, the sub-pixel SP may include a driving transistor DRT, a scan transistor SCT, a sensing transistor SENT, a storage capacitor Cst, and a light-emitting device ED.

The driving transistor DRT has a first node N1, a second node N2, and a third node N3. The first node N1 of the driving transistor DRT may be a gate node to which the data voltage VDATA from the data driving circuit 130 is applied through the data line DL when the scan transistor SCT is turned on. The second node N2 of the driving transistor DRT may be electrically connected to the anode electrode of the light-emitting device ED and may serve as a source node or a drain node. The third node N3 of the driving transistor DRT may be electrically connected to the high-potential voltage line DVL to which the sub-pixel driving voltage EVDD of a high potential is applied and may serve as a drain node or a source node.

During the display driving period, the sub-pixel driving voltage EVDD required for displaying images may be supplied through the high-potential voltage line DVL.

The scan transistor SCT is electrically connected to the first node N1 of the driving transistor DRT and the data line DL, and its gate node is connected to the gate line GL. It operates according to the scan signal SCAN supplied through the gate line GL. When the scan transistor SCT is turned on, it transmits the data voltage VDATA supplied through the data line DL to the gate node of the driving transistor DRT, thereby controlling the operation of the driving transistor DRT.

The sensing transistor SENT is electrically connected to the second node N2 of the driving transistor DRT and the reference voltage line RVL, and its gate node is connected to the gate line GL. It operates according to the sense signal SENSE supplied through the gate line GL. When the sensing transistor SENT is turned on, the sensing reference voltage Vref supplied through the reference voltage line RVL is transmitted to the second node N2 of the driving transistor DRT.

That is, by controlling the scan transistor SCT and the sensing transistor SENT, the first node N1 voltage and the second node N2 voltage of the driving transistor DRT are controlled, thereby allowing a current to be supplied to drive the light-emitting device ED.

The gate nodes of the scan transistor SCT and the sensing transistor SENT may be connected to a single gate line GL or to different gate lines GL. Here, an example is illustrated in which the scan transistor SCT and the sensing transistor SENT are connected to different gate lines GL. In this case, the scan transistor SCT and the sensing transistor SENT can be independently controlled by the scan signal SCAN and the sense signal SENSE transmitted through different gate lines GL.

On the other hand, when the scan transistor SCT and the sensing transistor SENT are connected to a single gate line GL, both transistors can be controlled simultaneously by the scan signal SCAN or the sense signal SENSE transmitted through the single gate line GL.

Meanwhile, in FIG. 3, all transistors arranged in the sub-pixel SP are illustrated as n-type transistors. However, embodiments of the present disclosure are not limited thereto, and at least one of the scan transistor SCT, the driving transistor DRT, and the sensing transistor SENT may be configured as a p-type transistor.

The storage capacitor Cst is electrically connected to the first node N1 and the second node N2 of the driving transistor DRT and maintains the data voltage VDATA for one frame.

Depending on the type of the driving transistor DRT, the storage capacitor Cst may be connected to the first node N1 and the third node N3 of the driving transistor DRT.

The anode electrode of the light-emitting device ED may be electrically connected to the second node N2 of the driving transistor DRT, and a low-potential base voltage EVSS may be applied to the cathode electrode of the light-emitting device ED. Here, the base voltage EVSS may be a ground voltage or a voltage higher or lower than the ground voltage. Furthermore, the base voltage EVSS may be variable depending on the driving state. For example, the base voltage EVSS at the display driving time and the base voltage EVSS at the sensing driving time may be set differently.

FIG. 3 illustrates a sub-pixel SP having a 3T (Transistor) 1C (Capacitor) structure. However, embodiments of the present disclosure are not limited thereto, and in some cases, one or more additional transistors or one or more additional capacitors may be included. Additionally, each of the plurality of sub-pixels SP may have the same structure, or some of the plurality of sub-pixels SP may have different structures.

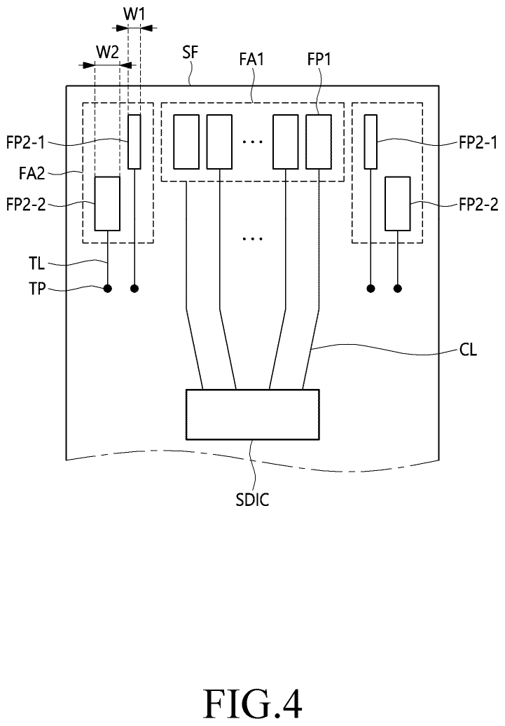

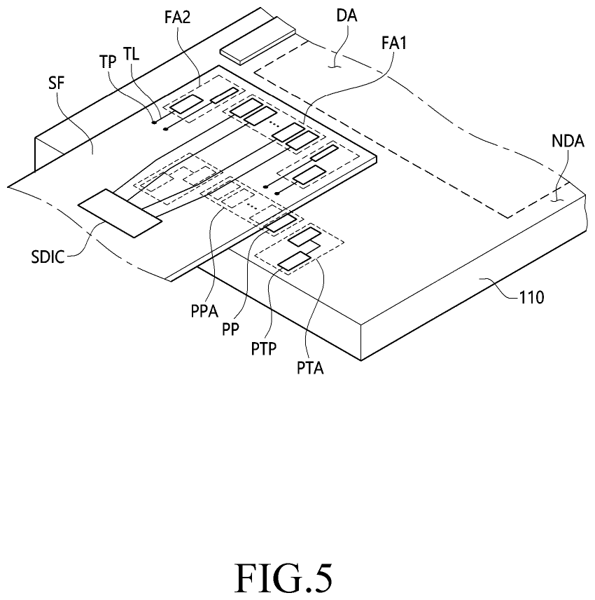

FIG. 4 and FIG. 5 are diagrams illustrating film pads included in the display device 100 according to embodiments of the present disclosure.

Specifically, FIG. 4 illustrates an implementation example of the source film SF included in the display device 100 according to embodiments of the present disclosure. FIG. 5 is a perspective view showing an enlarged bonding area where the display panel 110 and the source film SF are bonded in the display device 100 according to embodiments of the present disclosure.

In FIG. 4 and FIG. 5, for convenience of explanation, a source film SF implemented using a chip-on-film (COF) method is illustrated. However, the following description can also be easily applied to a gate film in a display device 100 that includes a gate film implemented using the chip-on-film method.

Referring to FIG. 4, the source film SF according to embodiments of the present disclosure may include a first pad portion FA1 in which a plurality of first film pads FP1 are arranged, a second pad portion FA2 which is arranged on at least one of a first side (e.g., left side) and a second side (e.g., right side) of the first pad portion FA1 and includes a plurality of second film pads FP2-1 and FP2-2, and at least one driving circuit electrically connected to the plurality of first film pads FP1.

Hereinafter, the second film pads FP2-1 and FP2-2 may also be referred to as film test pads.

In the example of FIG. 4, the driving circuit may be a source driving integrated circuit SDIC. However, embodiments of the present disclosure are not limited thereto, and depending on the embodiment, the driving circuit may also be a gate driving integrated circuit arranged in a gate film.

Each of the plurality of first film pads FP1 may be electrically connected to the source driving integrated circuit SDIC through a corresponding connection line CL.

Each of the plurality of second film pads FP2-1 and FP2-2 may be connected to a plurality of test terminals TP through test lines TL.

At least two or more test terminals TP among the plurality of test terminals may be connected to a test device that measures the bonding resistance between the display panel 110 and the source film SF.

At least two or more second film pads FP2-1 and FP2-2 among the plurality of second film pads may have different widths.

Specifically, the plurality of second film pads FP2-1 and FP2-2 may include at least one second-1 film pad FP2-1 having a first width W1 and at least one second-2 film pad FP2-2 having a second width W2 greater than the first width W1.

For example, the plurality of first film pads FP1 may have the same second width W2 as the second-2 film pads FP2-2. However, embodiments of the present disclosure are not limited thereto.

In the example of FIG. 4, at least one second-1 film pad FP2-1 is arranged in a region adjacent to the plurality of first film pads FP1, and at least one second-2 film pad FP2-2 is arranged in a region relatively farther from the first film pads FP1 compared to the second-1 film pads FP2-1.

However, embodiments of the present disclosure are not limited thereto, and at least one second-2 film pad FP2-2 may be arranged in a region closer to the plurality of first film pads FP1 than at least one second-1 film pad FP2-1.

At least one second-1 film pad FP2-1 and at least one second-2 film pad FP2-2 may be arranged in different rows or in the same row.

In the example of FIG. 4, at least one second-1 film pad FP2-1 is arranged in the same row as the plurality of first film pads FP1, and at least one second-2 film pad FP2-2 is arranged in a different row from at least one second-1 film pad FP2-1 and the plurality of first film pads FP1. However, embodiments of the present disclosure are not limited thereto.

For example, at least one second-1 film pad FP2-1, at least one second-2 film pad FP2-2, and the plurality of first film pads FP1 may all be arranged in the same row.

Additionally, at least one second-1 film pad FP2-1 and at least one second-2 film pad FP2-2 may be arranged in the same row while being arranged in a different row from the plurality of first film pads FP1.

Furthermore, at least one second-1 film pad FP2-1, at least one second-2 film pad FP2-2, and each of the plurality of first film pads FP1 may be arranged in different rows.

According to an embodiment, at least two of the plurality of first film pads FP1 may be arranged in different rows.

Referring to FIG. 5, the source film SF may be bonded to the display panel 110 in the non-display area NDA of the display panel 110.

Specifically, the substrate of the display panel 110 may include a panel pad portion PPA, in which a plurality of panel pads PP are arranged, and a panel test portion PTA, in which a plurality of panel test pads PTP are arranged on at least one of a first side (e.g., left side) and a second side (e.g., right side) of the panel pad portion PPA.

For example, the plurality of panel pads PP may be arranged in the non-display area NDA at positions corresponding to each of the plurality of first film pads FP1, and the plurality of panel test pads PTP may be arranged at positions corresponding to each of the plurality of second film pads FP2-1 and FP2-2.

In other words, the plurality of panel pads PP may be arranged at positions where they can contact the corresponding plurality of first film pads FP1 when the display panel 110 and the source film SF are bonded, and the plurality of panel test pads PTP may be arranged at positions where they can contact the corresponding plurality of second film pads FP2 when the display panel 110 and the source film SF are bonded.

At least one pad among the plurality of panel pads PP may be connected to at least one sub-pixel SP, and when the display panel 110 and the source film SF are bonded, it may be in contact with the plurality of first film pads FP1 and electrically connected to the source driving integrated circuit SDIC.

According to an embodiment, at least one pad among the plurality of panel pads PP may be in contact with the plurality of first film pads FP1 provided in the gate film when the display panel 110 and the gate film are bonded, thereby being electrically connected to the gate driving integrated circuit.

The plurality of panel test pads PTP may be dummy pads arranged on the substrate of the display panel 110, and at least two or more panel test pads PTP may be connected to each other through lines.

In the example of FIG. 5, on the substrate of the display panel 110, two panel test pads PTP arranged on the first side (e.g., left side) of the plurality of panel pads PP may be connected to each other through lines, and two panel test pads PTP arranged on the second side (e.g., right side) of the plurality of panel pads PP may be connected to each other through lines.

The substrate of the display panel 110 is a silicon substrate that includes a plurality of gate lines GL, a plurality of data lines DL, and a plurality of sub-pixels SP. The test device connected to the plurality of test terminals TP may measure the bonding resistance after the display panel 110 and the source film SF are bonded and determine whether a misalignment error has occurred in the display panel 110 based on the measurement result of the bonding resistance.

However, embodiments of the present disclosure are not limited thereto, and the substrate of the display panel 110 may be a conventional display substrate such as a glass substrate or a sapphire substrate.

That is, the display device 100 according to embodiments of the present disclosure can easily identify misalignment errors between the display panel 110 and the source film SF through electrical measurement (i.e., resistance measurement) using a plurality of second film pads FP2-1 and FP2-2 having different widths, even in an environment where optical measurement is difficult, such as when a silicon substrate is applied as the substrate of the display panel 110.

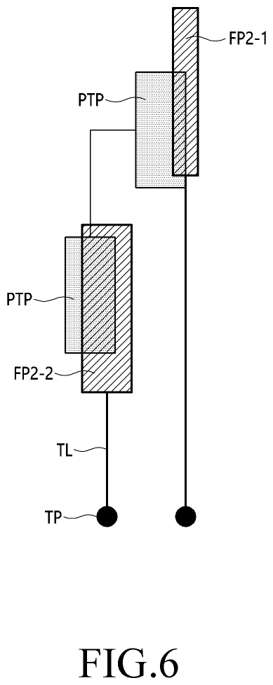

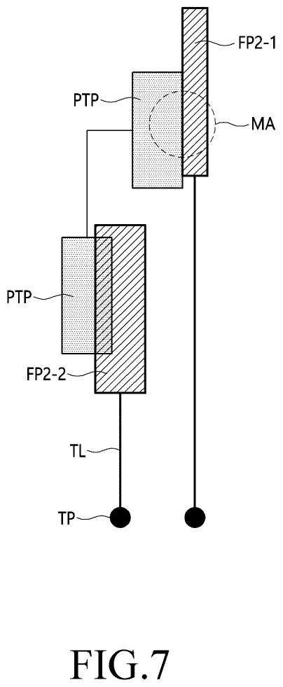

FIG. 6 and FIG. 7 are diagrams illustrating an example of determining a misalignment error in the display device 100 according to embodiments of the present disclosure.

Referring to FIG. 6 and FIG. 7, the display device 100 according to embodiments of the present disclosure may determine whether a misalignment error has occurred between the display panel 110 and the source film SF through an electrical measurement method using a plurality of second film pads FP2-1 and FP2-2 having different widths.

Specifically, each of the plurality of second film pads FP2-1 and FP2-2 may be connected to a plurality of test terminals TP through test lines TL. The test device is connected to the plurality of test terminals TP and measures the bonding resistance value based on the contact status and contact area of each of the plurality of second film pads FP2-1 and FP2-2 arranged on the source film SF and each of the plurality of panel test pads PTP arranged on the display panel 110. Based on the measured bonding resistance value, the test device may determine whether a misalignment error has occurred.

For example, if the measured bonding resistance value is within a preset normal resistance range, meaning it is a normal resistance value, the test device may determine that no misalignment error has occurred.

Additionally, if the measured bonding resistance value exceeds or falls below the preset normal resistance range, meaning it is an abnormal resistance value, the test device may determine that a misalignment error has occurred.

More specifically, the preset normal resistance range may be set by considering the resistance values corresponding to the contact areas of the second-1 film pad FP2-1 having a first width W1, the second-2 film pad FP2-2 having a second width W2 greater than the first width W1, and their respective corresponding panel test pads PTP.

The display device 110 according to embodiments of the present disclosure may optimize at least one of the width, length, thickness, and material of the test lines TL according to the contact areas of the plurality of second film pads FP2-1 and FP2-2 and the plurality of panel test pads PTP to improve the accuracy of bonding resistance measurement.

In the example of FIG. 6, the test device connected to the plurality of test terminals TP may derive a normal resistance value as a result of the bonding resistance measurement if the contact area of the second-1 film pad FP2-1 and its corresponding panel test pad PTP is at least a first threshold area and the contact area of the second-2 film pad FP2-2 and its corresponding panel test pad PTP is at least a second threshold area. Based on this, the test device may determine that no misalignment error has occurred.

In the example of FIG. 7, if the contact area of the second-2 film pad FP2-2 and its corresponding test terminal TP is at least the second threshold area, but the contact area of the second-1 film pad FP2-1 and its corresponding test terminal TP is less than the first threshold area, or if the second-1 film pad FP2-1 and the test terminal TP are in an open state (i.e., “MA” in FIG. 7), the test device connected to the plurality of test terminals TP may derive an abnormal resistance value as a result of the bonding resistance measurement. Based on this, the test device may determine that a misalignment error has occurred.

According to an embodiment, the test device connected to the plurality of test terminals TP may derive the misalignment direction (i.e., the direction of misalignment) based on the measurement result of the bonding resistance.

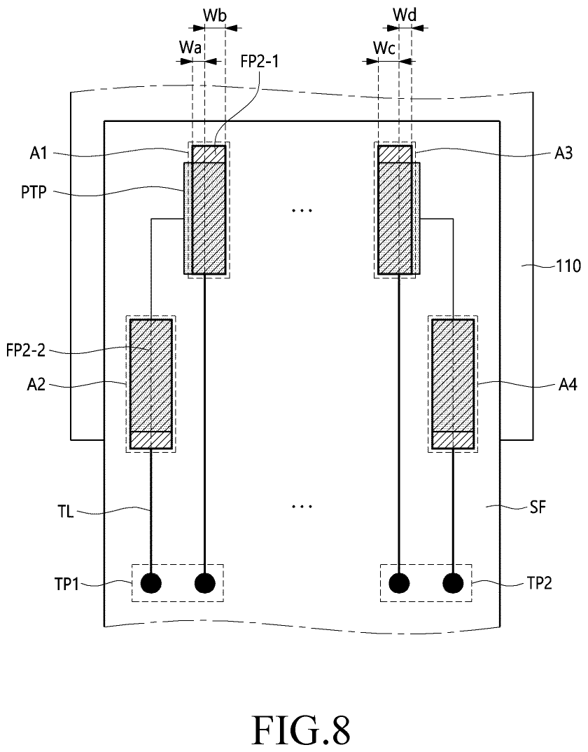

FIG. 8 to FIG. 10 are diagrams illustrating an example of deriving a misalignment direction in the display device 100 according to embodiments of the present disclosure.

Referring to FIG. 8 to FIG. 10, the second pad portion FA2 of the source film SF according to embodiments of the present disclosure may include: a first pad area A1, which is located in the same row as the plurality of first film pads FP1 on a first side (e.g., left side) of the first pad portion FA1, a second pad area A2, which is located in a different row from the plurality of first film pads FP1 on the first side of the first pad portion FA1, a third pad area A3, which is located in the same row as the plurality of first film pads FP1 on a second side (e.g., right side) of the first pad portion FA1, and a fourth pad area A4, which is located in a different row from the plurality of first film pads FP1 on the second side of the first pad portion FA1.

One of the second-1 film pad FP2-1 and the second-2 film pad FP2-2 may be arranged in the first pad area A1 and the third pad area A3, while the other may be arranged in the second pad area A2 and the fourth pad area A4.

That is, according to an embodiment, the second-1 film pad FP2-1 and the second-2 film pad FP2-2 arranged on the source film SF may be arranged in a left-right symmetric structure.

In the example of FIG. 8, the second-1 film pad FP2-1 is arranged in the first pad area A1 and the third pad area A3, while the second-2 film pad FP2-2 is arranged in the second pad area A2 and the fourth pad area A4.

However, embodiments of the present disclosure are not limited thereto, and the second-2 film pad FP2-2 may be arranged in the first pad area A1 and the third pad area A3, while the second-1 film pad FP2-1 may be arranged in the second pad area A2 and the fourth pad area A4.

One of the second-1 film pad FP2-1 and the second-2 film pad FP2-2 may be arranged in the first pad area A1 and the fourth pad area A4, while the other may be arranged in the second pad area A2 and the third pad area A3.

That is, according to an embodiment, the second-1 film pad FP2-1 and the second-2 film pad FP2-2 arranged on the source film SF may also be arranged in a left-right asymmetric structure.

For example, the second-1 film pad FP2-1 may be arranged in the first pad area A1 and the fourth pad area A4, while the second-2 film pad FP2-2 may be arranged in the second pad area A2 and the fourth pad area A4.

Alternatively, the second-2 film pad FP2-2 may be arranged in the first pad area A1 and the fourth pad area A4, while the second-1 film pad FP2-1 may be arranged in the second pad area A2 and the fourth pad area A4.

The second-1 film pad FP2-1 arranged on the first side of the first pad portion FA1 may have a first-1 width Wa and a first-2 width Wb on the left and right, respectively, based on the position of the corresponding test line TL.

In the example of FIG. 8, the second-1 film pad FP2-1 arranged on the first side of the first pad portion FA1 is located in the first pad area A1. The test line TL connected to any one of the plurality of first test terminals TP1 serves as a centerline, and the pad may have a first-1 width Wa and a first-2 width Wb. Here, the sum of the first-1 width Wa and the first-2 width Wb may be equal to the first width W1 (i.e., W1=Wa+Wb).

The second-1 film pad FP2-1 arranged on the second side of the first pad portion FA1 may have a first-3 width Wc and a first-4 width Wd on the left and right, respectively, based on the position of the corresponding test line TL.

In the example of FIG. 8, the second-1 film pad FP2-1 arranged on the third side of the first pad portion FA1 is located in the third pad area A3. The test line TL connected to any one of the plurality of second test terminals TP2 serves as a centerline, and the pad may have a first-3width Wc and a first-4 width Wd. Here, the sum of the first-3 width Wc and the first-4 width Wd may be equal to the first width W1 (i.e., W1=Wc+Wd).

That is, according to an embodiment, the second-1 film pads FP2-1 arranged in different pad areas on the source film SF may be designed with asymmetric widths, thereby allowing the misalignment direction to be easily determined.

In the example of FIG. 8, the first-1 width Wa may be smaller than the first-2 width Wb, and the first-3 width Wc may be greater than the first-4 width Wd.

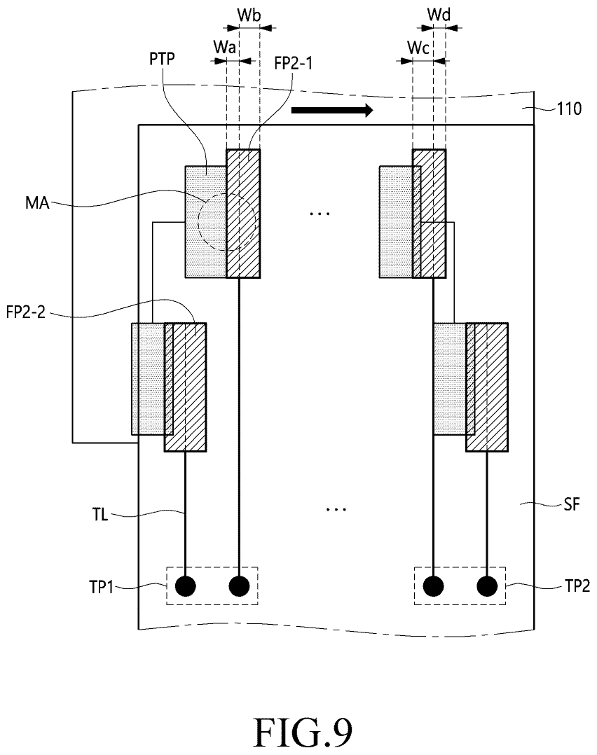

In this case (i.e., Wa<Wb, Wc>Wd), as illustrated in FIG. 9, if the bonding resistance measurement result through the plurality of first test terminals TP1 is an abnormal resistance value, and the bonding resistance measurement result through the plurality of second test terminals TP2 is a normal resistance value, the test device may determine the misalignment direction as a right misalignment.

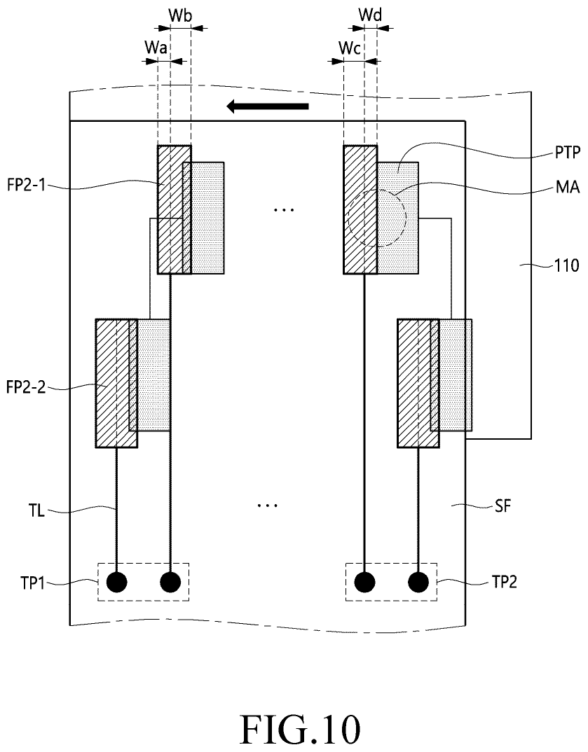

Additionally, as illustrated in FIG. 10, if the bonding resistance measurement result through the plurality of first test terminals TP1 is a normal resistance value, and the bonding resistance measurement result through the plurality of second test terminals TP2 is an abnormal resistance value, the test device may determine the misalignment direction as a left misalignment.

Here, a right misalignment means that the source film SF has shifted to the right from the normal bonding position, while a left misalignment means that the source film SF has shifted to the left from the normal bonding position.

According to an embodiment, the first-1 width Wa may be greater than the first-2 width Wb, and the first-3 width Wc may be smaller than the first-4 width Wd.

In this case (i.e., Wa>Wb, Wc<Wd), if the bonding resistance measurement result through the plurality of first test terminals TP1 is a normal resistance value and the bonding resistance measurement result through the plurality of second test terminals TP2 is an abnormal resistance value, the test device may determine the misalignment direction as a right misalignment.

Additionally, if the bonding resistance measurement result through the plurality of first test terminals TP1 is an abnormal resistance value and the bonding resistance measurement result through the plurality of second test terminals TP2 is a normal resistance value, the test device may determine the misalignment direction as a left misalignment.

According to an embodiment, the first-1 width Wa may be equal to the first-4 width Wd, and the first-2 width Wb may be equal to the first-3 width Wc. However, embodiments of the present disclosure are not limited thereto, and the first-1 width Wa, first-2 width Wb, first-3 width Wc, and first-4 width Wd may be designed to have different sizes.

A summary of the embodiments of the present disclosure described above is as follows.

The display device according to embodiments of the present disclosure comprises: a first pad portion in which a plurality of first film pads are arranged; a second pad portion that includes a plurality of second film pads arranged on at least one of a first side and a second side of the first pad portion, and a plurality of test terminals electrically connected to each of the plurality of second film pads through test lines; and at least one driving circuit electrically connected to the plurality of first film padsm, wherein at least two of the plurality of second film pads may have different widths.

The plurality of second film pads may include at least one second-1 film pad having a first width and at least one second-2 film pad having a second width greater than the first width.

The second-1 film pad and the second-2 film pad may be arranged in the same row as the plurality of first film pads.

The second pad portion may comprise: a first pad area, which is located in the same row as the plurality of first film pads on the first side; a second pad area, which is located in a different row from the plurality of first film pads on the first side; a third pad area, which is located in the same row as the plurality of first film pads on the second side; and a fourth pad area, which is located in a different row from the plurality of first film pads on the second side.

One of the second-1 film pad and the second-2 film pad may be arranged in the first pad area and the third pad area, while the other may be arranged in the second pad area and the fourth pad area.

One of the second-1 film pad and the second-2 film pad may be arranged in the first pad area and the fourth pad area, while the other may be arranged in the second pad area and the third pad area.

The second-1 film pad arranged on the first side may have a first-1 width and a first-2 width on the left and right, respectively, based on the position of the test line connected to the second-1 film pad arranged on the first side. The second-1 film pad arranged on the second side may have a first-3 width and a first-4 width on the left and right, respectively, based on the position of the test line connected to the second-1 film pad arranged on the second side.

The first-1 width may be smaller than the first-2 width, and the first-3 width may be greater than the first-4 width.

The first-1 width may be greater than the first-2 width, and the first-3 width may be smaller than the first-4 width.

The plurality of second film pads may be arranged at positions corresponding to each of the plurality of panel test pads arranged on the substrate of the display panel, and at least two of the the plurality of test terminals may be electrically connected to a test device that measures bonding resistance.

The plurality of panel test pads may be dummy pads arranged in regions adjacent to the plurality of panel pads on the substrate.

The substrate may be a silicon substrate that includes a plurality of gate lines, a plurality of data lines, and a plurality of sub-pixels.

The test device may determine whether a misalignment error has occurred in the display panel based on the measurement result of the bonding resistance.

The test device may derive the misalignment direction in the display panel based on the measurement result of the bonding resistance.

The display device according to embodiments of the present disclosure comprises: a display panel that includes a display area in which a plurality of sub-pixels are arranged, and a non-display area in which a first driving circuit and a plurality of panel test pads are arranged; at least one source film in which a plurality of film test pads corresponding to each of the plurality of panel test pads and connected to each of a plurality of test terminals through test lines, and a second driving circuit are arranged; and a control board in which a controller for controlling the first and second driving integrated circuits is arranged, wherein at least two of the plurality of film test pads may have different widths.

The plurality of film test pads may include at least one second-1 film pad having a first width and at least one second-2 film pad having a second width greater than the first width.

The above description has been presented to enable any person skilled in the art to make and use the technical idea of the present invention and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present invention. The above description and the accompanying drawings provide an example of the technical idea of the present invention for illustrative purposes only. That is, the disclosed embodiments are intended to illustrate the scope of the technical idea of the present invention.

What is claimed is:

1. A display device comprising:
a first pad portion in which a plurality of first film pads are disposed;
a second pad portion including a plurality of second film pads on at least one of a first side and a second side of the first pad portion and a plurality of test terminals electrically connected to each of the plurality of second film pads through test lines; and
at least one driving circuit electrically connected to the plurality of first film pads,
wherein at least two or more of the plurality of second film pads have different widths.

2. The display device according to claim 1, wherein the plurality of second film pads comprises:
at least one second-1 film pad having a first width; and
at least one second-2 film pad having a second width greater than the first width.

3. The display device according to claim 2, wherein the at least one second-1 film pad and the at least one second-2 film pad are arranged in a same row as the plurality of first film pads.

4. The display device according to claim 2, wherein the second pad portion comprises:
a first pad area positioned in a same row as the plurality of first film pads on the first side,
a second pad area positioned in a different row from the plurality of first film pads on the first side,
a third pad area positioned in the same row as the plurality of first film pads on the second side, and
a fourth pad area positioned in a different row from the plurality of first film pads on the second side.

5. The display device according to claim 4, wherein one of the at least one second-1 film pad and the at least one second-2 film pad is in the first pad area and the third pad area, and another one of the at least one second-1 film pad and the at least one second-2 film pad is in the second pad area and the fourth pad area.

6. The display device according to claim 4, wherein one of the at least one second-1 film pad and the at least one second-2 film pad is in the first pad area and the fourth pad area, and another one of the at least one second-1 film pad and the at least one second-2 film pad is in the second pad area and the third pad area.

7. The display device according to claim 2, wherein the at least one second-1 film pad on the first side has a first-1 width and a first-2 width on a left and a right, respectively, based on a position of a test line from the test lines that is connected to the at least one second-1 film pad disposed on the first side; and
wherein the at least one second-1 film pad on the second side has a first-3 width and a first-4 width on the left and right, respectively, based on a position of a test line from the test lines that is connected to the at least one second-1 film pad disposed on the second side.

8. The display device according to claim 7, wherein the first-1 width is smaller than the first-2 width and the first-3 width is greater than the first-4 width.

9. The display device according to claim 7, wherein the first-1 width is greater than the first-2 width and the first-3 width is smaller than the first-4 width.

10. The display device according to claim 1, wherein the plurality of second film pads are at positions corresponding to each of a plurality of panel test pads arranged on a substrate of a display panel; and
at least two or more of the plurality of test terminals are electrically connected to a test device that measures bonding resistance.

11. The display device according to claim 10, wherein the plurality of panel test pads are dummy pads in regions adjacent to a plurality of panel pads arranged on the substrate.

12. The display device according to claim 10, wherein the substrate is a silicon substrate including a plurality of gate lines, a plurality of data lines, and a plurality of sub-pixels.

13. The display device according to claim 10, wherein the test device is configured to determine whether a misalignment error occurs in the display panel based on a measurement result of the bonding resistance.

14. The display device according to claim 13, wherein the test device is configured to derive a misalignment direction in the display panel based on the measurement result of the bonding resistance.

15. A display device comprising:
a display area including a plurality of sub-pixels and a non-display area including a first driving circuit and a plurality of panel test pads;
at least one source film, where a plurality of film test pads corresponding to the plurality of panel test pads and connected to each of a plurality of test terminals through a test line, and a second driving circuit are arranged; and
a control board where a controller is disposed, the controller configured to control both the first driving circuit and the second driving circuit;
wherein at least two of the plurality of film test pads have different widths.

16. The display device according to claim 15, wherein the plurality of film test pads comprise at least one second-1 film pad having a first width and at least one second-2 film pad having a second width that is greater than the first width.
